(19) United States
(12) Patent Application Publication
(10) Pub. No.: US 2022/0403216 A1
(43) Pub. Date: Dec. 22, 2022

(54) ADHESION PROMOTING COMPOSITION AND METHOD FOR PRODUCING LAMINATE, AND FILM FORMING COMPOSITION AND METHOD FOR PRODUCING FILM

(71) Applicant: Merck Patent GmbH, Darmstadt (DE)

(72) Inventors: Yoshio NOJIMA, Kakegawa-shi (JP); Atsuko NOYA, Kakegawa-shi (JP)

(21) Appl. No.: 17/777,664

(22) PCT Filed: Nov. 16, 2020
(86) PCT No.: PCT/EP2020/082180

§ 371 Date: May 18, 2022

(30) Foreign Application Priority Data
Nov. 19, 2019 (JP) 2019-208750

(51) Int. Cl. C09J 11/06; C08K 5/548; B32B 7/12; B32B 15/08; B32B 27/28; C08J 5/18

(52) U.S. Cl. CPC C09J 11/06; C08K 5/548; B32B 7/12; B32B 15/08; B32B 27/283; C08J 5/18; C09J 2203/326; B32B 2250/02; B32B 2311/04; B32B 2383/00; B32B 2457/14

(57) ABSTRACT

The present invention provides an adhesion promoting composition, or a sulfide compound-containing polysiloxane composition, having good adhesion, capable of forming a laminate having high adhesion between a metal layer and a polysiloxane layer. The adhesion promoting composition according to the present invention is an adhesion promoting composition applied to between a metal layer and a polysiloxane layer, and comprises a sulfide compound having a certain structure and a solvent. The sulfide compound-containing polysiloxane composition according to the present invention comprises a sulfide compound having a certain structure, a polysiloxane, and a solvent.

### BACKGROUND OF THE INVENTION

### Technical Field

The present invention relates to an adhesion promoting composition and a method for producing a laminate, and a film forming composition and a method for producing a film.

### Background Art

Mainly in the field of semiconductor, a siliceous film, which is formed by applying a liquid composition comprising a silicon-containing polymer such as polysiloxane and curing it, is used as an insulating film.

Aluminum and copper have been conventionally used as materials for forming wiring on substrates such as semiconductor wafers, and gold and silver are also used. Since these metals have low reactivity, improvement in adhesion is a problem when forming the insulating film such as the above-mentioned. An insulating film forming material for improving the adhesion has been proposed (for example, Patent Document 1).

Gold is used for wiring of the LED device, which has been particularly noticed in recent years. Gold has low reactivity, and it is required to easily form an insulating film having good adhesion on wiring.

### PRIOR ART DOCUMENTS

### Patent Documents

[Patent document 1] JP 2011-52065 A

### SUMMARY OF THE INVENTION

### Problems to be Solved by the Invention

The present invention provides an adhesion promoting composition capable of forming a laminate having high adhesion between a metal layer and a polysiloxane layer. Further, the present invention provides a film forming composition having good adhesion. Furthermore, the formed laminate and film have good light resistance.

### Means for Solving the Problems

The adhesion promoting composition according to the present invention is an adhesion promoting composition which is applied to between a metal layer and a polysiloxane layer. The adhesion promoting composition comprises:

a sulfide compound represented by the formula (a):

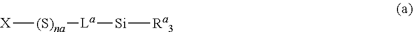

wherein

na is an integer of 1 to 5,

X is a hydrogen atom, alkyl having 1 to 4 carbon atoms which may be substituted with mercapto, or -L^{a}-Si—R^{a}₃,

L^{a} is each independently alkylene having 1 to 4 carbon atoms,

R^{a} is each independently selected from the group consisting of hydroxy, alkyl having 1 to 4 carbon atoms and alkoxy having 1 to 4 carbon atoms, and the alkyl and the alkoxy may be substituted with mercapto, provided that at least one of R^{a} is alkoxy; and

a solvent.

The method for producing a laminate comprising a metal layer and a polysiloxane layer according to the present invention comprises:

applying the adhesion promoting composition to a metal layer or a polysiloxane layer to form a sulfide compound layer; and

forming a metal layer or a polysiloxane layer on the sulfide compound layer.

The laminate according to the present invention is one produced by the above-mentioned method.

The electronic device according to the present invention comprises the above-mentioned laminate.

The film forming composition according to the present invention comprises:

a sulfide compound represented by the formula (a):

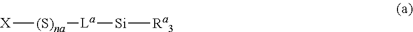

wherein

na is an integer of 1 to 5,

X is a hydrogen atom, alkyl having 1 to 4 carbon atoms which may be substituted with mercapto, or -L^{a}-Si—R^{a}₃,

L^{a} is each independently alkylene having 1 to 4 carbon atoms,

R^{a} is each independently selected from the group consisting of hydroxy, alkyl having 1 to 4 carbon atoms and alkoxy having 1 to 4 carbon atoms, and the alkyl and the alkoxy may be substituted with mercapto, provided that at least one of R^{a} is alkoxy;

a polysiloxane; and

a solvent.

The method for producing a film according to the present invention comprises:

applying the above-mentioned film forming composition to a substrate to form a film forming composition layer; and

heating the film forming composition layer.

The film is one produced by the above-mentioned method.

The electronic device according to the present invention comprises the film produced by the above-mentioned method.

### Effects of the Invention

According to the adhesion promoting composition of the present invention, it is possible to form a laminate having high adhesion between a metal layer and a polysiloxane layer. Further, according to the film forming composition of the present invention, it is possible to form a film having high adhesion. Furthermore, the formed laminate or film has good light resistance. Moreover, according to the present invention, a film containing polysiloxane having good properties can be more easily produced.

### DETAILED DESCRIPTION OF THE INVENTION

### Mode for Carrying Out the Invention

Embodiments of the present invention are described below in detail.

In the present specification, symbols, units, abbreviations, and terms have the following meanings unless otherwise specified.

In the present specification, unless otherwise particularly mentioned, the singular form includes the plural form and “one” or “that” means “at least one”. In the present specification, unless otherwise particularly mentioned, an element of a concept can be expressed by a plurality of species, and when the amount (for example, mass % or mol %) is described, it means sum of the plurality of species. “And/or” includes a combination of all elements and also includes single use of the element.

In the present specification, when a numerical range is indicated using “to” or “-”, it includes both endpoints and units thereof are common. For example, 5 to 25 mol % means 5 mol % or more and 25 mol % or less.

In the present specification, the hydrocarbon means one including carbon and hydrogen, and optionally including oxygen or nitrogen. The hydrocarbyl group means a monovalent or divalent or higher valent hydrocarbon. In the present specification, the aliphatic hydrocarbon means a linear, branched or cyclic aliphatic hydrocarbon, and the aliphatic hydrocarbon group means a monovalent or divalent or higher valent aliphatic hydrocarbon. The aromatic hydrocarbon means a hydrocarbon comprising an aromatic ring which may optionally not only comprise an aliphatic hydrocarbon group as a substituent but also be condensed with an alicycle. The aromatic hydrocarbon group means a monovalent or divalent or higher valent aromatic hydrocarbon. Further, the aromatic ring means a hydrocarbon comprising a conjugated unsaturated ring structure, and the alicycle means a hydrocarbon having a ring structure but comprising no conjugated unsaturated ring structure.

In the present specification, the alkyl means a group obtained by removing any one hydrogen from a linear or branched, saturated hydrocarbon and includes a linear alkyl and branched alkyl, and the cycloalkyl means a group obtained by removing one hydrogen from a saturated hydrocarbon comprising a cyclic structure and optionally includes a linear or branched alkyl in the cyclic structure as a side chain.

In the present specification, the aryl means a group obtained by removing any one hydrogen from an aromatic hydrocarbon. The alkylene means a group obtained by removing any two hydrogens from a linear or branched, saturated hydrocarbon. The arylene means a hydrocarbon group obtained by removing any two hydrogens from an aromatic hydrocarbon.

In the present specification, the sulfide means a divalent group represented by —S—. The polysulfide means a group in which a plurality of —S— are continuously bonded. Further, —S— contained in thiol (—SH) is also included in the sulfide for convenience.

In the present specification, the descriptions such as “C_{x-y}”, “Cₓ-C_{y}” and “Cₓ” mean the number of carbons in the molecule or substituent group. For example, C₁-6 alkyl means alkyl having 1 to 6 carbons (such as methyl, ethyl, propyl, butyl, pentyl and hexyl). Further, the fluoroalkyl as used in the present specification refers to one in which one or more hydrogen in alkyl is replaced with fluorine, and the fluoroaryl is one in which one or more hydrogen in aryl are replaced with fluorine.

In the present specification, when polymer has a plural types of repeating units, these repeating units copolymerize. These copolymerization are any of alternating copolymerization, random copolymerization, block copolymerization, graft copolymerization, or a mixture of any of these.

In the present specification, “%” represents mass % and “ratio” represents ratio by mass.

In the present specification, Celsius is used as the temperature unit. For example, 20 degrees means 20 degrees Celsius.

### <Adhesion Promoting Composition>

The adhesion promoting composition according to the present invention is an adhesion promoting composition applied to between a metal layer and a polysiloxane layer, and the composition comprises a sulfide compound and a solvent.

The adhesion promoting composition according to the present invention is applied to the metal layer before forming the polysiloxane layer or the polysiloxane layer before forming the metal layer, preferably to the metal layer (more preferably a substrate having a metal surface), and further preferably to metal wiring such as a semiconductor device. Examples of the metal used for the metal wiring include aluminum, copper, silver, gold, molybdenum, chromium, titanium and tungsten, and preferably gold.

The materials used in the present invention are described below.

### [Sulfide Compound]

The sulfide compound used in the present invention is represented by the formula (a):

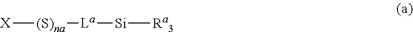

wherein

na is an integer of 1 to 5,

X is a hydrogen atom, alkyl having 1 to 4 carbon atoms which may be substituted with mercapto, or -L^{a}-Si—R^{a}₃,

L^{a} is each independently alkylene having 1 to 4 carbon atoms,

R^{a} is each independently selected from the group consisting of hydroxy, alkyl having 1 to 4 carbon atoms and alkoxy having 1 to 4 carbon atoms, and the alkyl and the alkoxy may be substituted with mercapto, provided that at least one of R^{a} is alkoxy.

Preferably, the sulfide compound is represented by the formula (b) or (c):

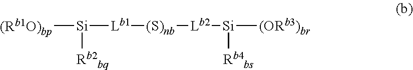

wherein

nb is an integer of 1 to 5, preferably an integer of 2 to 5,

L^{b1} and L^{b2} are each independently alkylene having 1 to 4 carbon atoms,

R^{b1} and R^{b3} are each independently a hydrogen atom or alkyl having 1 to 4 carbon atoms, preferably methyl or ethyl,

R^{b2} and R^{b4} are each independently alkyl having 1 to 4 carbon atoms, preferably methyl or ethyl, and bp and br are each independently an integer of 1 to 3, bq and bs are each independently an integer of 0 to 2, provided that bp+bq=3 and br+bs=3 are satisfied. It is also one preferable aspect that bq and bs are 0.

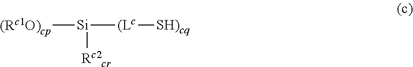

wherein

L^{c} is independently alkylene having 1 to 4 carbon atoms,

R^{c1} is a hydrogen atom or alkyl having 1 to 4 carbon atoms, preferably methyl or ethyl,

R^{c2} is alkyl having 1 to 4 carbon atoms, preferably methyl or ethyl, and

cp and cq are each independently an integer of 1 to 3 and cr is an integer of 0 to 2, provided that cp+cq+cr=4 is satisfied. It is also one preferable aspect that cr is 0.

Examples of the sulfide compound represented by the formula (b) include 3,3-tetrathiobis(propyl)triethoxy-silane, 3,3-tetrathiobis(propyl)trimethoxysilane, bis[3-(triethoxysilyl)propyl]pertrisulfide and bistriethoxysilyl-propyl disulfide.

Examples of the sulfide compound represented by the formula (c) include (3-mercaptopropyl)trimethoxy-silane, mercaptomethyltripropoxysilane, mercapto-methyltriethoxysilane, mercaptomethyltrimethoxysilane, (1-mercaptoethyl)triethoxysilane, (2-mercaptoethyl)triethoxysilane, (1-mercaptopropyl)methyldimethoxysilane, (2-mercaptopropyl)methyldimethoxysilane, (3-mercaptopropyl)methyldimethoxysilane, (1-mercaptopropyl)ethyldiethoxysilane, (2-mercaptopropyl)ethyldiethoxysilane, (3-mercaptopropyl)ethyldiethoxysilane, (1-mercaptopropyl)trimethoxysilane, (2-mercaptopropyl)trimethoxysilane, (3-mercaptopropyl)trimethoxysilane, (1-mercaptopropyl)triethoxysilane, (2-mercaptopropyl)triethoxysilane, and (3-mercaptopropyl)triethoxysilane.

The molecular weight of the sulfide compound is preferably 150 to 800, more preferably 250 to 600.

The sulfide compound used in the present invention comprises a structure containing sulfide and a structure containing silicon and alkoxy. Although not to be bound by theory, —OH is generated by hydrolysis from the alkoxy bonded to silicon, and this —OH and a group (for example, silanol) present in the polysiloxane layer undergo condensation polymerization to form a bond.

Further, sulfur in the sulfide compound forms a bond with the metal in the metal layer. It is considered that the above two kinds of bonds exert an adhesion promoting effect.

The content of the sulfide compound is preferably 0.01 to 5.0 mass %, more preferably 0.1 to 3.0 mass %, based on the total mass of the composition.

### [Solvent]

The solvent is not particularly limited as long as it uniformly dissolves or disperses the above-mentioned sulfide compound and the additive to be added as necessary and does not affect the metal. Examples of the solvent that can be used in the present invention include:

ethylene glycol monoalkyl ethers such as ethylene glycol monomethyl ether, ethylene glycol monoethyl ether, ethylene glycol monopropyl ether and ethylene glycol monobutyl ether;

diethylene glycol monoalkyl ethers such as diethylene glycol monohexyl ether;

diethylene glycol dialkyl ethers such as diethylene glycol dimethyl ether, diethylene glycol diethyl ether, diethylene glycol dipropyl ether and diethylene glycol dibutyl ether;

ethylene glycol alkyl ether acetates such as methyl cellosolve acetate and ethyl cellosolve acetate;

propylene glycol monoalkyl ethers such as propylene glycol monomethyl ether (PGME) and propylene glycol monoethyl ether;

propylene glycol alkyl ether acetates such as propylene glycol monomethyl ether acetate (PGMEA), propylene glycol monoethyl ether acetate, propylene glycol monopropyl ether acetate and propylene glycol diacetate;

aromatic hydrocarbons such as benzene, toluene and xylene;

ketones such as methyl ethyl ketone, acetone, methyl amyl ketone, methyl isobutyl ketone and cyclohexanone;

alcohols such as ethanol, propanol, butanol, hexanol, cyclohexanol, ethylene glycol and glycerin;

esters such as ethyl lactate, ethyl 3-ethoxypropionate and methyl 3-methoxypropionate;

cyclic esters such as γ-butyrolactone; and the like.

Preferred are diethylene glycol monoalkyl ethers, propylene glycol alkyl ether acetates, propylene glycol monoalkyl ethers, cyclic esters, and esters. More preferably, the solvent comprises at least one selected from the group consisting of propylene glycol monomethyl ether acetate, propylene glycol monomethyl ether, γ-butyrolactone, propylene glycol diacetate, diethylene glycol monohexyl ether and methyl 3-methoxypropionate. The solvent is used alone or in combination of two or more, and the amount thereof used varies depending on the coating method and the demand for the film thickness after coated.

The content of the solvent can be appropriately selected in consideration of the coating method to be adopted. The content of the solvent is preferably 1 to 90 mass %, more preferably 20 to 70 mass %, based on the total mass of the composition.

The composition according to the present invention essentially comprises a sulfide compound and a solvent, but further compounds can be combined if necessary.

### [Surfactant]

Surfactants can be added for the purpose of improving coating properties, developability and the like.

Examples of the surfactant that can be used in the present invention include nonionic surfactants, anionic surfactants, amphoteric surfactants, and the like.

Examples of the nonionic surfactant include, polyoxyethylene alkyl ethers, such as polyoxyethylene lauryl ether, polyoxyethylene oleyl ether and polyoxyethylene cetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, such as Fluorad (trade name, 3M Japan Limited), Megafac (trade name, DIC Corporation), Surflon (trade name, AGC Inc.); or organosiloxane surfactants, such as KP341 (trade name, Shin-Etsu Chemical Co., Ltd.). Examples of the above-described acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-di-methyl-3-hexyne-2,5-diol, 2,5-di-methyl-2,5-hexanediol, and the like.

Further, examples of the anionic surfactant include ammonium salt or organic amine salt of alkyl diphenyl ether disulfonic acid, ammonium salt or organic amine salt of alkyl diphenyl ether sulfonic acid, ammonium salt or organic amine salt of alkyl benzene sulfonic acid, ammonium salt or organic amine salt of polyoxyethylene alkyl ether sulfuric acid, ammonium salt or organic amine salt of alkyl sulfuric acid, and the like.

Further, examples of the amphoteric surfactant include 2-alkyl-N-carboxymethyl-N-hydroxyethyl imidazolium betaine, lauric acid amide propyl hydroxysulfone betaine, and the like.

These surfactants can be used alone or as a mixture of two or more types, and the content thereof is preferably 0.005 to 1 mass %, more preferably 0.01 to 0.5 mass %, based on the total mass of the composition.

### [Other Additives]

In the adhesion promoting composition according to the present invention, further compounds other than the above-mentioned can be combined as other additives. The content of the other additives is preferably 10 mass % or less, and more preferably 5 mass % or less, based on the total mass of the composition.

### <Method for Producing a Laminate Using the Adhesion Promoting Composition>

The method for producing a laminate comprising a metal layer and a polysiloxane layer according to the present invention comprises:

applying the adhesion promoting composition according to the present invention to a metal layer or a polysiloxane layer to form a sulfide compound layer; and

forming a metal layer or a polysiloxane layer on the sulfide compound layer.

A sulfide compound layer can be formed on a metal layer and then a polysiloxane layer can be formed, or a sulfide compound layer can be formed on a polysiloxane layer and then a metal layer can be formed.

A preferred method for producing a laminate comprising a metal layer and a polysiloxane layer comprises:

applying the adhesion promoting composition according to the present invention to a metal layer to form a sulfide compound layer; and

applying a composition comprising a polysiloxane to the sulfide compound layer to form a polysiloxane layer.

The metal layer is preferably a substrate having a metal surface. As the substrate used for the substrate having a metal surface, any appropriate one such as silicon substrate, glass substrate and resin film can be used. Examples of the metal include gold, silver, copper, aluminum, molybdenum, chromium, titanium and tungsten, and preferably gold. Preferably, the substrate having a metal surface is a substrate having metal wiring.

The application of the adhesion promoting composition can be carried out by any conventionally known method for applying a composition. In particular, it can be freely selected from dip coating, roll coating, bar coating, brush coating, spray coating, doctor coating, flow coating, spin coating, slit coating, and the like.

After application of the adhesion promoting composition, the coating film can be pre-baked (heat treatment) if necessary, in order to dry the coating film and reduce the residual amount of the solvent. The pre-baking step is generally performed at a temperature of 70 to 150° C., preferably 90 to 140° C., in the case of a hot plate, for 10 to 180 seconds, preferably 30 to 90 seconds and in the case of a clean oven, for 1 to 30 minutes. It is also a preferable aspect that no pre-baking is performed.

A composition comprising a polysiloxane is applied to the formed sulfide compound layer. The composition comprising polysiloxane preferably comprises, for example, the polysiloxane described later, a thermal acid generator or thermal base generator described later, the above-mentioned surfactant, and the above-mentioned solvent.

The method for applying the composition comprising polysiloxane is the same as mentioned above, and after application, the coating film can be pre-baked (heat treatment) if necessary, in order to dry the coating film and reduce the residual amount of the solvent. The pre-baking step is generally performed at a temperature of 70 to 150° C., preferably 90 to 140° C., in the case of a hot plate, for 10 to 180 seconds, preferably 30 to 90 seconds, and in the case of a clean oven, for 1 to 30 minutes.

After optionally performing the above-mentioned pre-baking, it can be further heated. By this heating, the coating film can be cured. The heating temperature in this heating process is not particularly limited and can be freely determined as long as it is a temperature at which dehydration condensation of polysiloxane proceeds and the coating film can be cured. However, if the silanol group remains, the chemical resistance of the cured film sometimes becomes insufficient, or the leakage current of the cured film sometimes becomes higher. From such viewpoints, a relatively high temperature is generally selected as the heating temperature. In order to accelerate the curing reaction and obtain a sufficiently cured film, the heating temperature is preferably 130 to 300° C., more preferably 180 to 250° C. Further, the heating time is not particularly limited and is generally 1 minute to 2 hours, preferably 5 minutes to 30 minutes. In addition, this heating time is a time from when the temperature of the film reaches a desired heating temperature. Usually, it takes about several minutes to several hours for the film to reach a desired temperature from the temperature before heating. The heating is performed in an inert gas atmosphere or an oxygen-containing atmosphere such as the air.

### <Electronic Device>

The laminate according to the present invention is further subjected to post-treatments such as processing and circuit formation as necessary to form electronic devices. For these post-treatments, any conventionally known method can be applied.

### <Film Forming Composition>

The film forming composition according to the present invention comprises a sulfide compound, a polysiloxane and a solvent. The sulfide compound and the solvent are as described above.

### [Polysiloxane]

The polysiloxane used in the present invention is not particularly limited and can be selected from any one according to the purpose. Depending on the number of oxygen atoms bonded to a silicon atom, the skeleton structure of polysiloxane can be classified as follows: a silicone skeleton (the number of oxygen atoms bonded to a silicon atom is 2), a silsesquioxane skeleton (the number of oxygen atoms bonded to a silicon atom is 3), and a silica skeleton (the number of oxygen atoms bonded to a silicon atom is 4). In the present invention, any of these can be used. Polysiloxane molecule can contain multiple combinations of these skeleton structures.

Preferably, the polysiloxane used in the present invention comprises a repeating unit represented by the formula (Ia):

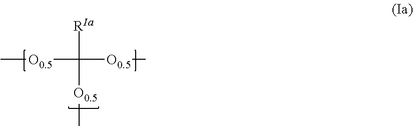

wherein

R^{1a} is hydrogen, a C₁₋₃₀ (preferably C₁₋₁₀) linear, branched or cyclic, saturated or unsaturated, aliphatic hydrocarbon group or aromatic hydrocarbon group,

the aliphatic hydrocarbon group and the aromatic hydrocarbon group are each unsubstituted or substituted with fluorine, hydroxy or alkoxy, and

in the aliphatic hydrocarbon group and the aromatic hydrocarbon group, methylene is not replaced, or one or more methylene is replaced by oxy, imino or carbonyl, provided that R^{1a} is neither hydroxy nor alkoxy.

Here, the above-described methylene also includes a terminal methyl.

Further, the above-described “substituted with fluorine, hydroxy or alkoxy” means that a hydrogen atom directly bonded to a carbon atom in an aliphatic hydrocarbon group and aromatic hydrocarbon group is replaced with fluorine, hydroxy or alkoxy. In the present specification, the same applies to other similar descriptions.

In the repeating unit represented by the formula (Ia), R^{1a} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{1a} is methyl is preferred, since raw material thereof is easily obtained, its film hardness after curing is high and it has high chemical resistance. Further, the compound wherein R^{1a} is phenyl is preferred since it increases solubility of the polysiloxane in the solvent and the cured film becomes hardly crackable.

The polysiloxane used in the present invention may further comprise a repeating unit represented by formula (Ib):

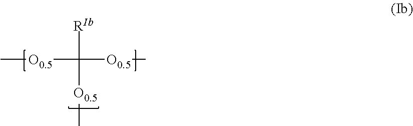

wherein

R^{Ib} is a group obtained by removing plural hydrogen from a nitrogen and/or oxygen-containing cycloaliphatic hydrocarbon compound having amino, imino and/or carbonyl.

In the formula (Ib), R^{Ib} is preferably a group obtained by removing plural hydrogen, preferably two or three hydrogen, from preferably a nitrogen-containing aliphatic hydrocarbon ring having imino and/or carbonyl, more preferably a 5-membered or 6-membered ring containing nitrogen as a member. For example, groups obtained by removing two or three hydrogen from piperidine, pyrrolidine or isocyanurate. R^{Ib} connects Si each other included in plural repeating units.

The polysiloxane used in the present invention may further comprise a repeating unit represented by the formula (Ic):

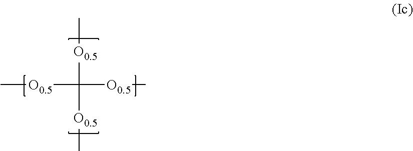

When the mixing ratio of the repeating units represented by the formulae (Ib) and (Ic) is high, compatibility with solvents and additives decreases, and the film stress increases so that cracks sometimes easily generate. Therefore, it is preferably 40 mol % or less with, more preferably 20 mol % or less, based on the total number of the repeating units of the polysiloxane.

The polysiloxane used in the present invention may further comprise a repeating unit represented by the formula (Id):

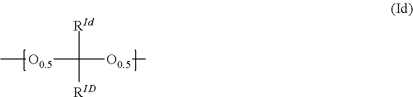

wherein

R^{Id} each independently represents hydrogen, a C₁₋₃₀ (preferably C₁₋₁₀) linear, branched or cyclic, saturated or unsaturated, aliphatic hydrocarbon group or aromatic hydrocarbon group;

the aliphatic hydrocarbon group and the aromatic hydrocarbon group are each unsubstituted or substituted with fluorine, hydroxy or alkoxy, and

in the aliphatic hydrocarbon group and the aromatic hydrocarbon group, methylene is not replaced or replaced with oxy, imide or carbonyl.

In the repeating unit represented by the formula (Id), R^{Id} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{Id} is methyl is preferred, since raw material thereof is easily obtained, its film hardness after curing is high and it has high chemical resistance. Further, the compound wherein R^{Id} is phenyl is preferred since it increases solubility of the polysiloxane in the solvent and the cured film becomes hardly crackable.

By having the repeating unit of the above formula (Id), it is possible to make the polysiloxane according to the present invention partially of a linear structure. However, since heat resistance is reduced, it is preferable that portions of linear structure are few. In particular, the repeating unit of the formula (Id) is preferably 30 mol % or less, more preferably 5 mol % or less, based on the total number of the repeating units of the polysiloxane. It is also one aspect of the present invention to have no repeating unit of the formula (Id) (0 mol %).

The polysiloxane used in the present invention may contain two or more types of repeating units. For example, it can contain three types of repeating units having repeating units represented by the formula (Ia) in which R^{1a} is methyl or phenyl and a repeating unit represented by the formula (Ic).

In addition, the polysiloxane used in the composition according to the present invention preferably has silanol. Here, the silanol refers to one in which an OH group is directly bonded to the Si skeleton of polysiloxane and is one in which hydroxy is directly attached to a silicon atom in the polysiloxane comprising repeating units such as the above formulae (Ia) to (Id). That is, the silanol is composed by bonding —O_{0.5}H to —O_{0.5}- in the above formulae (Ia) to (Id). The content of the silanol in polysiloxane varies depending on the conditions for synthesizing polysiloxane, for example, the mixing ratio of the monomers, the type of the reaction catalyst and the like. The content of this silanol can be evaluated by quantitative infrared absorption spectrum measurement. The absorption band assigned to silanol (SiOH) appears as an absorption band having a peak in the range of 900±100 cm⁻¹ in the infrared absorption spectrum. When the content of the silanol is high, the intensity of this absorption band increases.

In the present invention, in order to quantitatively evaluate the silanol content, the intensity of the absorption band assigned to Si—O is used as a reference. An absorption band having a peak in the range of 1100±100 cm⁻¹ is adopted as a peak assigned to Si—O. The silanol content can be relatively evaluated by the ratio S2/S1, which is a ratio of the integrated intensity S2 of the absorption band assigned to SiOH to the integrated intensity S1 of the absorption band assigned to Si—O. In the present invention, the ratio S2/S1 is preferably 0.003 to 0.15, more preferably 0.01 to 0.10.

The integrated intensity of the absorption band is determined in consideration of noise in the infrared absorption spectrum. In a typical infrared absorption spectrum of polysiloxane, an absorption band assigned to Si—OH having a peak in the range of 900±100 cm⁻¹ and an absorption band assigned to a Si—O having a peak in the range of 1100±100 cm⁻¹ are confirmed. The integrated intensity of these absorption bands can be measured as an area in consideration of a baseline in which noise and the like are considered. Incidentally, there is a possibility that the foot of the absorption band assigned to Si—OH and the foot of the absorption band assigned to Si—O are overlapped; however, in such a case, the wavenumber corresponding to the minimal point between the two absorption bands in the spectrum is set as their boundary. The same applies to the case where the foot of the other absorption band overlaps with the foot of the absorption band assigned to Si—OH or Si—O.

The mass average molecular weight of the polysiloxane used in the present invention is not particularly limited. However, the higher the molecular weight, the more the coating properties tend to be improved. On the other hand, the lower the molecular weight is, the less synthesis conditions are limited, so that the synthesis is easy, and the synthesis of polysiloxane having a remarkably high molecular weight is difficult. For these reasons, the mass average molecular weight of polysiloxane is usually 500 to 25,000, and preferably 1,000 to 20,000 from the viewpoint of solubility in an organic solvent. Here, the mass average molecular weight means a mass average molecular weight in terms of polystyrene, which can be measured by the gel permeation chromatography based on polystyrene.

### [Method for Synthesizing Polysiloxane]

Although the method for synthesizing the polysiloxane used in the present invention is not particularly limited, it can be obtained by hydrolysis and polymerization of a silane monomer, for example, one represented by the following formula, in the presence of an acidic catalyst or a basic catalyst as needed:

R^{ia}-Si—(OR^{ia′})₃ (ia)

wherein

R^{ia} is hydrogen, a C₁₋₃₀ (preferably C₁₋₁₀) linear, branched or cyclic, saturated or unsaturated, aliphatic hydrocarbon group or aromatic hydrocarbon group,

the aliphatic hydrocarbon group and the aromatic hydrocarbon group are each unsubstituted or substituted with fluorine, hydroxy or alkoxy,

in the aliphatic hydrocarbon group and the aromatic hydrocarbon group, methylene is not replaced or replaced with oxy, imide or carbonyl, and

R^{ia′} is linear or branched, C₁₋₆ alkyl.

In the formula (ia), preferred R^{ia′} includes methyl, ethyl, n-propyl, isopropyl, n-butyl and the like. In the formula (ia), a plurality of R^{ia′} are contained, and each R^{ia′} can be identical or different.

The preferred R^{ia′} is the same as the preferred R^{Ia} described above.

Specific examples of the silane monomer represented by the formula (ia) include, for example, methyltrimethoxysilane, methyltriethoxysilane, methyltriisopropoxysilane, methyltri-n-butoxysilane, ethyltrimethoxysilane, ethyltriethoxysilane, ethyltriisopropoxysilane, ethyltri-n-butoxysilane, n-propyltrimethoxysilane, n-propyltriethoxysilane, n-butyltrimethoxysilane, n-butyltriethoxysilane, n-hexyltrimethoxysilane, n-hexyltriethoxysilane, decyltrimethoxysilane, phenyltrimethoxysilane, phenyltriethoxysilane, trifluoromethyltrimethoxysilane, trifluoromethyltriethoxysilane, and 3,3,3-trifluoropropyltrimethoxysilane. Among these, methyltrimethoxysilane, methyltriethoxysilane, methyltripropoxysilane, and phenyltrimethoxysilane are preferable. It is preferable that two or more types of silane monomers represented by the formula (ia) are combined.

Further, a silane monomer represented by the following formula (ic) can be combined. When the silane monomer represented by the formula (ic) is used, polysiloxane comprising the repeating unit (Ic) can be obtained.

Si(OR^{ic′})₄ (ic)

wherein R^{ic′} is linear or branched, C₁₋₆ alkyl.

In the formula (ic), preferred R^{ic′} includes methyl, ethyl, n-propyl, isopropyl, n-butyl and the like. In the formula (ic), a plurality of R^{ic′} are included, and each R^{ic′} can be identical or different.

Specific examples of the silane monomer represented by the formula (ic) include tetramethoxysilane, tetraethoxysilane, tetraisopropoxy-silane, tetra n-butoxysilane and the like.

A silane monomer represented by the following formula (ib) can be further combined:

R^{ib}—Si—(OR^{ib′})₃ (ib)

wherein

R^{ib′} is linear or branched, C₁₋₆ alkyl, and examples thereof include methyl, ethyl, n-propyl, isopropyl, n-butyl, and the like. A plurality of R^{ib′} are contained in one monomer, and each R^{ib′} can be identical or different.

R^{ib} is a group obtained by removing plural, preferably two or three, hydrogens from a nitrogen and/or oxygen-containing cyclic aliphatic hydrocarbon compound having an amino group, an imino group and/or a carbonyl group. The preferred R^{ib} is the same as the preferred R^{Ib} described above.

Specific examples of the silane monomer represented by the formula (ib) include tris-(3-trimethoxysilylpropyl)isocyanurate, tris-(3-triethoxysilylpropyl)isocyanurate, tris-(3-trimethoxysilylethyl)isocyanurate and the like.

Furthermore, a silane monomer represented by the following formula (id) may be combined. When the silane monomer represented by the formula (id) is used, polysiloxane containing the repeating unit (Id) can be obtained:

(R^{id})₂—Si—(OR^{id′})₂ (id)

wherein

R^{id′} is each independently linear or branched, C₁₋₆ alkyl, and examples thereof include methyl, ethyl, n-propyl, isopropyl, n-butyl, and the like. A plurality of R^{id′} are contained in one monomer, and each R^{id′} can be identical or different,

R^{id} each independently represents hydrogen, a C₁₋₃₀ (preferably C₁₋₁₀) linear, branched or cyclic, saturated or unsaturated, aliphatic hydrocarbon group or aromatic hydrocarbon group, and

the aliphatic hydrocarbon group and the aromatic hydrocarbon group are each unsubstituted or substituted with fluorine, hydroxy or alkoxy, and

in the aliphatic hydrocarbon group and aromatic hydrocarbon group, methylene is not replaced or replaced with oxy, imino or carbonyl. The preferred R^{id} is the same as the preferred R^{Id} described above.

### [Thermal Acid Generator or Thermal Base Generator]

The film forming composition according to the present invention preferably further comprises a thermal acid generator or a thermal base generator. These are preferably selected according to the polymerization reaction or crosslinking reaction used in the film producing process.

The optimum content of these depends on the type and the amount of active substances generated by decomposition. If the content is high, cracks sometimes occur in the formed film or coloring due to decomposition of these sometimes become noticeable, so that the colorless transparency of the film sometimes decreases. In addition, thermal decomposition may cause deterioration of the electrical insulation of the cured product or release of gas, which sometimes causes problems in subsequent processes. Therefore, the content of the thermal acid generator or the thermal base generator is preferably 0.1 to 10 mass %, more preferably 0.5 to 5 mass %, based on the total mass of the polysiloxane.

In the present invention, the thermal acid generator or the thermal base generator refers to a compound that causes bond cleavage by heat to generate an acid or a base. It is preferable that these do not generate an acid or a base, or generate only a small amount, by the heat at the time of prebaking after applying the composition.

Examples of the thermal acid generator include salts and esters that generate organic acids, which are various aliphatic sulfonic acids and salts thereof, various aliphatic carboxylic acids such as citric acid, acetic acid, and maleic acid, and salts thereof; various aromatic carboxylic acids such as benzoic acid and phthalic acid, and salts thereof; aromatic sulfonic acids and ammonium salts thereof; various amine salts; aromatic diazonium salts and phosphonic acids and salts thereof; and the like.

Among the thermal acid generators, salts of organic acids and organic bases are preferable, and salts of sulfonic acids and organic bases are further preferable. Preferred sulfonic acids include p-toluenesulfonic acid, benzenesulfonic acid, p-dodecylbenzenesulfonic acid, 1,4-naphthalenedisulfonic acid, methanesulfonic acid and the like. These thermal acid generators can be used alone or in combination.

Examples of thermal base generator include compounds that generate bases, such as imidazole and tertiary amines, and mixtures thereof. Examples of the bases to be released are imidazole derivatives such as N-(2-nitrobenzyloxycarbonyl)imidazole, N-(3-nitrobenzyloxycarbonyl)imidazole, N-(4-nitrobenzyloxycarbonyl)imidazole, N-(5-methyl-2-nitrobenzyloxycarbonyl)imidazole and N-(4-chloro-2-nitrobenzyloxycarbonyl)imidazole, and 1,8-diazabicyclo[5.4.0]undecene-7. Similar to the acid generator, these base generators can be used alone or in combination.

### [Other Additives]

The film forming composition according to the present invention may comprise the above-mentioned surfactant and the like as other additives. The content of the other additives is preferably 5 mass % or less, more preferably 1 mass % or less, based on the total mass of the composition.

### <Method for Forming a Film Using the Film Forming Composition>

The method for producing a film according to the present invention comprises:

applying the film forming composition to a substrate to form a film forming composition layer; and

heating the film forming composition layer.

The substrate is not particularly limited, but any appropriate one such as silicon substrate, glass substrate and resin film can be used. The substrate is preferably a substrate having a metal surface, more preferably a substrate having metal wiring. Examples of the metal of the metal wiring include gold, silver, copper, aluminum, molybdenum, chromium, titanium and tungsten, and preferably gold. It is also a preferred aspect of the present invention to form a film on a substrate having no metal surface using the film forming composition of the present invention and then form a metal layer thereon.

The application of the film forming composition in the present invention can be carried out by any conventionally known method for applying a composition. In particular, it can be freely selected from dip coating, roll coating, bar coating, brush coating, spray coating, doctor coating, flow coating, spin coating, slit coating and the like.

After application of the film forming composition according to the present invention, the coating film can be pre-baked (heat treatment) if necessary, in order to dry the coating film and reduce the residual amount of the solvent. The pre-baking step is generally performed at a temperature of 70 to 150° C., preferably 90 to 140° C., in the case of a hot plate, for 10 to 180 seconds, preferably 30 to 90 seconds, and in the case of a clean oven, for 1 to 30 minutes.

The formed film forming composition layer is further heated to cure the coating film and form a film. The heating temperature in this heating process is not particularly limited and can be freely determined as long as it is a temperature at which dehydration condensation of polysiloxane proceeds and the coating film can be cured. However, if silanol remains, the chemical resistance of the film sometimes becomes insufficient, or the leakage current of the film sometimes becomes higher. From such viewpoints, a relatively high temperature is generally selected as the heating temperature. In order to accelerate the curing reaction and obtain a sufficient film, the heating temperature is preferably 130 to 300° C., more preferably 180 to 250° C. Further, the heating time is not particularly limited and is generally 1 minute to 2 hours, preferably 5 minutes to 30 minutes. In addition, this heating time is a time from when the temperature of the pattern film reaches a desired heating temperature. Usually, it takes about several minutes to several hours for the pattern film to reach a desired temperature from the temperature before heating. The heating is performed in an inert gas atmosphere or an oxygen-containing atmosphere such as the air.

### <Electronic Device>

The film according to the present invention has good insulating performance and can be used as an insulating film. The formed insulating film is then optionally subjected to post-treatments such as processing and circuit formation to form an electronic device. For these post-treatments, any conventionally known method can be applied.

### EXAMPLE

The present invention is described more particularly with reference to Examples and Comparative Examples, but the present invention is not limited to these Examples and Comparative Examples at all.

### Example 101

Into a solvent PGMEA, a sulfide compound 3,3′-tetrathiobis(propyltriethoxysilane) and a surfactant KF-53 (manufactured by Shin-Etsu Chemical Co., Ltd.) were added to make the contents thereof respectively 2 mass % and 0.5 mass %, and the resultant was stirred, thereby preparing the adhesion promoting composition of Example 101.

### Examples 102 to 106, and Comparative Examples 101 and 102

Adhesion promoting compositions of Examples 102 to 106, and Comparative Examples 101 and 102 were prepared in the same manner as in Example 101, except that the type and concentration of the sulfide compound and the solvent were changed to those shown in Table 1.

TABLE 1

| | | Composition | | | Evaluation | |
|---|---|---|---|---|---|---|
| | | | | | | Light resistance |
| | | Surfide compound | | Solvent | Adhesion | Δa* |
| Example | 101 | 3,3′-tetrathiobis (propyltriethoxysilane) | 2 mass % | PGMEA | A | 0.01 |
| | 102 | 3,3′-tetrathiobis (propyltriethoxysilane) | 1 mass % | PGMEA | A | 0.04 |
| | 103 | 3,3′-tetrathiobis (propyltriethoxysilane) | 0.1 mass % | PGMEA | A | 0.12 |
| | 104 | 3,3′-tetrathiobis (propyltriethoxysilane) | 0.01 mass % | PGMEA | B | 0.13 |
| | 105 | 3,3′-tetrathiobis (propyltriethoxysilane) | 0.1 mass % | PGME | A | 0.12 |
| | 106 | (3-mercaptopropyl) trimethoxysilane | 1 mass % | PGMEA | B | 0.16 |
| Comparative | 101 | dibutyl disulfide | 1 mass % | PGMEA | C | 0.18 |
| Example | 102 | 1,2-bis (trimethoxysilyl) ethane | 1 mass % | PGMEA | C | 0.18 |
| | | uncoated substrate | — | — | — | 0.19 |

### Example 201

Into a 2 L flask equipped with a stirrer, a thermometer, and a cooling tube, 49.0 g of a 25 mass % tetramethylammonium hydroxide aqueous solution, 600 ml of isopropyl alcohol (IPA) and 4.0 g of water were charged, and then in a dropping funnel, a mixed solution of 60 g of methyl trimethoxysilane and 40 g of phenyltrimethoxysilane was prepared. The mixed solution was added dropwise at 40° C., the mixture was stirred at the same temperature for 2 hours, and then a 10 mass % HCl aqueous solution was added for neutralization. 400 ml of toluene and 600 ml of water were added to the neutralized liquid to separate into two phases, and the water phase was removed. Further washing three times with 300 ml of water, the obtained organic phase was concentrated under reduced pressure to remove the solvent, and PGMEA was added to the concentrate so as to have a solid content concentration of 35 mass %, thereby obtaining the polysiloxane A solution.

When the molecular weight (in terms of polystyrene) of the obtained polysiloxane A was measured by gel permeation chromatography, the mass average molecular weight was 1,400.

Into the polysiloxane A solution obtained above, a sulfide compound 3,3′-tetrathiobis(propyltriethoxysilane), a thermal base generator (1,8-diazabicyclo(5.4.0)-undecene-7-orthophthalic acid salt) and a surfactant KF-53 (manufactured by Shin-Etsu Chemical Co., Ltd.) were added to make the contents thereof respectively 1 mass %, 0.5 mass % and 0.5 mass %, further PGMEA was added so as to have a solid content concentration of 35 mass %, and the mixture was stirred, thereby preparing the siliceous film forming composition of Example 201.

### Examples 202 to 204, and Comparative Examples 201 and 202

The film forming compositions of Examples 202 to 204, and Comparative Examples 201 and 202 were prepared in the same manner as in Example 201, except that the type and concentration of the sulfide compound and the solvent were changed to those shown in Table 2.

TABLE 2

| | | Composition | | | Evaluation | |
|---|---|---|---|---|---|---|
| | | | | | | Light resistance |
| | | Surfide compound | | Solvent | Adhesion | Δa* |
| Example | 201 | 3,3′-tetrathiobis (propyltriethoxysilane) | 1 mass % | PGMEA | A | 0.02 |
| | 202 | 3,3′-tetrathiobis (propyltriethoxysilane) | 0.1 mass % | PGMEA | A | 0.03 |
| | 203 | 3,3′-tetrathiobis (propyltriethoxysilane) | 0.01 mass % | PGMEA | B | 0.11 |
| | 204 | (3-mercaptopropyl) trimethoxysilane | 1 mass % | PGMEA | B | 0.17 |
| Comparative | 201 | dibutyl disulfide | 1 mass % | PGMEA | C | 0.17 |
| Example | 202 | 1,2-bis (trimethoxysilyl) ethane | 1 mass % | PGMEA | C | 0.17 |
| | | uncoated substrate | — | — | — | 0.19 |

### <Formation of a Laminate>

The adhesion promoting composition of Examples 101 to 106, Comparative Examples 101 or 102 was applied by spin coating to a substrate having gold deposited on a silicon wafer so that the average film thickness was 50 nm. The polysiloxane composition A was applied thereon by spin coating so as to have an average film thickness of 2 μm, and heated on a hot plate at 130° C. for 90 seconds, thereby forming a laminate of Examples 101 to 106, Comparative Example 101 or 102.

### <Formation of a Film>

The film forming composition of Examples 201 to 204, Comparative Example 201 or 202 was applied by spin coating to a substrate having gold deposited on a silicon wafer so that the average film thickness was 2 μm, and heated on a hot plate at 130° C. for 90 seconds, thereby forming a film of Examples 201 to 204, Comparative Example 201 or 202.

### <Adhesion Evaluation>

The obtained laminate or film was cut to have a cut width of 1 mm and a hatch number of 25 according to JIS K5600. After a peeling tape (Nichiban CT24 (adhesive strength: 4.01 N/10 mm)) was adhered, the tape was peeled off and the cut surface was observed and evaluated as follows. The results obtained are shown in Tables 1 and 2.

A: No peeling was confirmed on the film.

B: Peeling of the film was not visually observed, but peeling was confirmed at the end part when a microscope was used.

C: Peeling of the film was visually confirmed on the entire surface.

Incidentally, when a film was formed using the above-mentioned polysiloxane composition A in the same manner as in Example 202, the adhesion evaluation result thereof was C.

### <Light Resistance Evaluation>

As to the obtained polysiloxane layer or film, the values of a*, b* and L* were measured using a spectrocolorimeter CM-5 (Konica Minolta). Then, it was left in a Q-SUN xenon arc tester (Q-Lab Corporation) under the conditions of a temperature of 25° C., a light source: Xe-Arc, an illuminance of 75 W/m² and an exposure amount of 20 million Lux hours. Then, it was taken out and the a*, b* and L* were measured again, and the respective changes (taking them as Δa*, Δb* and ΔL*, respectively) were measured. Incidentally, the uncoated substrates in Tables 1 and 2 are substrates in which gold was attached to a silicon substrate. For comparison, the same light resistance evaluation was also performed using the same.

As to the measurement results, Δa* was as shown in Tables 1 and 2. Δb* and ΔL* were in the same level in all of Examples and Comparative Examples.

1.-17. (canceled)

18. An adhesion promoting composition applied to between a metal layer and a polysiloxane layer, the composition comprising:
a sulfide compound represented by formula (a): 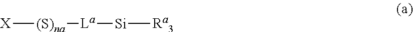
wherein
na is an integer of 1 to 5,
X is a hydrogen atom, alkyl having 1 to 4 carbon atoms which may be substituted with mercapto, or -L^{a}-Si—R^{a}₃,
L^{a} is each independently alkylene having 1 to 4 carbon atoms,
R^{a} is each independently selected from the group consisting of hydroxy, alkyl having 1 to 4 carbon atoms and alkoxy having 1 to 4 carbon atoms, and the alkyl and the alkoxy are optionally substituted with mercapto, provided that at least one of R^{a} is alkoxy; and
a solvent.

19. The composition according to claim 18, wherein the sulfide compound is represented by the formula (b) or (c): 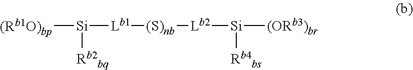
wherein
nb is an integer of 1 to 5,
L^{b1} and L^{b2} are each independently alkylene having 1 to 4 carbon atoms,
R^{b1} and R^{b3} are each independently a hydrogen atom or alkyl having 1 to 4 carbon atoms,
R^{b2} and R^{b4} are each independently alkyl having 1 to 4 carbon atoms, and
bp and br are each independently an integer of 1 to 3, bq and bs are each independently an integer of 0 to 2, provided that bp+bq=3 and br+bs=3 are satisfied; 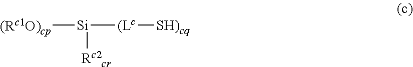
wherein
L^{c} is independently alkylene having 1 to 4 carbon atoms,
R^{c1} is a hydrogen atom or alkyl having 1 to 4 carbon atoms,
R^{c2} is alkyl having 1 to 4 carbon atoms, and
cp and cq are each independently an integer of 1 to 3, and cr is an integer of 0 to 2, provided that cp+cq+cr=4 is satisfied.

20. The composition according to claim 18, wherein the molecular weight of the sulfide compound is 150 to 800.

21. The composition according to claim 18, wherein the solvent comprises at least one selected from the group consisting of propylene glycol monomethyl ether acetate, propylene glycol monomethyl ether, γ-butyrolactone, propylene glycol diacetate, diethylene glycol monohexyl ether and methyl 3-methoxypropionate.

22. The composition according to a claim 18, further comprising a surfactant.

23. A method for producing a laminate comprising a metal layer and a polysiloxane layer, the method comprising:
applying the adhesion promoting composition according to claim 18 to a metal layer or a polysiloxane layer to form a sulfide compound layer, and
forming a metal layer or a polysiloxane layer on the sulfide compound layer.

24. The method according to claim 23, comprising:
applying the adhesion promoting composition according to claim 18 to a metal layer to form a sulfide compound layer; and
applying a composition comprising a polysiloxane to the sulfide compound layer to form a polysiloxane layer.

25. A laminate produced by the method according to claim 23.

26. An electronic device comprising the laminate according to claim 25.

27. A film forming composition comprising:
a sulfide compound represented by the formula (a): 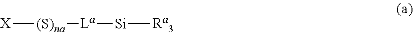
wherein
na is an integer of 1 to 5,
X is a hydrogen atom, alkyl having 1 to 4 carbon atoms which may be substituted with mercapto, or -L^{a}-Si—R^{a}₃,
L^{a} is each independently alkylene having 1 to 4 carbon atoms,
R^{a} is each independently selected from the group consisting of hydroxy, alkyl having 1 to 4 carbon atoms and alkoxy having 1 to 4 carbon atoms, and the alkyl and the alkoxy may be substituted with mercapto, provided that at least one of R^{a} is alkoxy;
a polysiloxane; and
a solvent.

28. The composition according to claim 27, wherein the sulfide compound is represented by the formula (b) or (c): 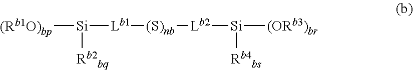
wherein
nb is an integer of 1 to 5,
L^{b1} and L^{b1} are each independently alkylene having 1 to 4 carbon atoms,
R^{b1} and R^{b3} are each independently a hydrogen atom or alkyl having 1 to 4 carbon atoms,
R^{b2} and R^{b4} are each independently alkyl having 1 to 4 carbon atoms, and
bp and br are each independently an integer of 1 to 3, bq and bs are each independently an integer of 0 to 2, provided that bp+bq=3 and br+bs=3 are satisfied; 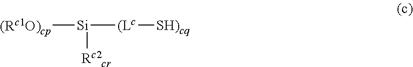
wherein
L^{c} is independently alkylene having 1 to 4 carbon atoms,
R^{c1} is a hydrogen atom or alkyl having 1 to 4 carbon atoms,
R^{c2} is alkyl having 1 to 4 carbon atoms, and
cp and cq are each independently an integer of 1 to 3, and cr is an integer of 0 to 2, provided that cp+cq+cr=4 is satisfied.

29. The composition according to claim 27, wherein the polysiloxane comprises a repeating unit represented by the formula (Ia): 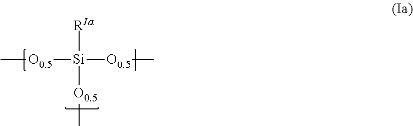
wherein
R^{1a} is hydrogen, a C₁₋₃₀ linear, branched or cyclic, saturated or unsaturated, aliphatic hydrocarbon group or aromatic hydrocarbon group,
the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{1a} is neither hydroxy nor alkoxy.

30. The composition according to claim 27, further comprising a thermal acid generator or a thermal base generator.

31. A method for producing a film, comprising:
applying the film forming composition according to claim 27 to a substrate to form a film forming composition layer; and
heating the film forming composition layer.

32. The method according to claim 31, wherein the substrate is a substrate having a metal surface.

33. A film produced by the method according to claim 31.

34. An electronic device comprising the film produced by the method according to claim 33.
